(19) United States
(12) Patent Application Publication
(10) Pub. No.: US 2002/0048312 A1
(43) Pub. Date: Apr. 25, 2002

(54) Sensor assembly

(76) Inventors: Dana K. Schurr, Fridley, MN (US); Patrick L. Bachman, Edina, MN (US); Ted A. Moe, Minneapolis, MN (US); Daniel J. Powley, Coon Rapids, MN (US)

Correspondence Address: NAWROCKI, ROONEY & SIVERTSON, P.A., Broadway Place East, Suite 401, 3433 Broadway Street N. E., Minneapolis, MN, 55413, US

(21) Appl. No.: 09/860,391

(22) Filed: May 18, 2001

Related U.S. Application Data
(60) Provisional application No. 60/205,156, filed on May 18, 2000.

(51) Int. Cl. G01K 1/00

(52) U.S. Cl. 374/208

(57) ABSTRACT

A sensing device, including a housing and at least one sensing element, is provided. The housing includes an elongate base having a longitudinal slot therein, and an elongate cover having at least a single profiled longitudinal edge. The at least a single profiled longitudinal edge is reversibly received in a portion of the longitudinal slot of the elongate base so as to enclose the at least one sensing element.

This is a regular application filed under 35 U.S.C. §111(a) claiming priority under 35 U.S.C. §119(e)(1), of provisional application Ser. No. 60/205,156 having a filing date of May 18, 2000, filed under 35 U.S.C. §111(b).

### TECHNICAL FIELD

The present invention generally relates to a sensing device, more particularly to a sensing assembly including a non-laminated sensing element housing, and yet more particularly to a stator temperature detector.

### BACKGROUND OF THE INVENTION

Although each sensing application presents its own particular challenge, in all such applications the integrity of the sensor is critical, with the sensing element, the leads, and the housing being all subject to compromise to some degree or another. Of great industrial importance has been thermal overload protection for motors, generators, turbines, and the like, as by the utilization of stator temperature sensors, bearing sensors, etc.

The fact that the electrical resistance of a metal wire increases with rising temperature is the basis for a very useful class of temperature sensors. One has only to calibrate a given length of wire, as to its resistance in relation to temperature, enclose it in a suitable protecting tube or case, and keep it connected with a resistance measuring bridge. Industrial resistance thermometers, often referred to as resistance temperature detectors (RTDs), generally comprise an assembly of parts which include the sensing element, typically of platinum, nickel or copper construction, internal lead wires, internal supporting and insulating material, and a protective housing. The most widely used forms of construction for RTDs are wire wound, wherein resistive windings (e.g., platinum coils) are housed in ceramic tubes, and thin-film, wherein a resistive film is deposited onto a ceramic substrate.

Stator RTDs, sometimes referred to as “stick” RTDs due to their elongated configuration, are fit between the windings of a motor or the like to provide an early warning of temperature rise to prevent insulation overheating and catastrophic machine failure. Due to their flexible construction, RTDs are likewise well suited for temperature measurement on flat or uneven surfaces, thereby finding a variety uses. Although such RTDs are generally resistant to mechanical strain and deformation, the resistance characteristics thereof cannot be influenced either by the assembling of the RTDs into the stator windings or by bending onto curved surfaces.

Heretofore known stick RTDs are constructed using well known lamination processes. Typically an elongated base will be adapted to receive of one or more temperature sensing elements, thereafter a cover is laminated thereover to form an RTD stick, or an RTD stick segment. Commercially available lamination presses for fabricating RTDs typically may have a long (i.e., length) dimension of 24 inches, with lengths of up to about 6 feet not unheard of for producing same. Although a majority of applications specify stick RTDs falling within such range, a not insignificant number of applications require stick RTDs to 20 feet in length or more. As end to end stick length is limited by the fabrication process, applications requiring a RTD having a length dimension exceeding that of the lamination press has required an integration of RTD stick segments, as by a lapped construction, or other known splicing means, so as to form a single stick of desired length. Needless to say, this manufacturing approach, including the product manufactured thereby, has its drawbacks and limitations.

First, the assembly process is time-consuming and expensive, with the necessary “piece-work” risking misplacement and or misalignment of the critical sensing element components. Many additional steps, including those of machining and assembly, are further required to obtain a finished product. Furthermore, considerable attention is necessary during fabrication of “integrated” stick RTDs (i.e., integration of the discrete stick segments into a single element) to ensure that the integrity of the lead wires are not comprised, as by pinching, twisting, etc. Often times redundant sensing functions are specified in anticipation of premature failure of the sensing element or component thereof.

Second, the lack of homogeneity in the stick (i.e., the several joints or splices necessitated to obtain the desired stick length) results in stress strain behavior which is less than optimal in the finished product. Furthermore, such stick RTDs typically do not exhibit a predictable flexure, a property which in most applications is essential.

### SUMMARY OF THE INVENTION

A sensor assembly, including at least a single sensing element contained within a body, is provided. The body includes a base and a cover, the base being adapted to receive at least a portion of the cover so as to form an interface therewith. More particularly, the housing includes an elongate base having a longitudinal slot therein, and an elongate cover having at least a single profiled longitudinal edge. The at least a single profiled longitudinal edge is reversibly received in a portion of the longitudinal slot of the elongate base so as to enclose the at least one sensing element. Finally, in an alternate embodiment, a portion of the cover is conjoined to a portion of the base wherein a free longitudinal edge of the cover is hingedly positionable for receipt within a slot of the base.

The subject invention provides quick and reliable snap-together fabrication of sensor assemblies, and more narrowly, stick RTDs. Twenty to thirty foot stick RTDs may be easily constructed from single (i.e., unitary) cooperative elements (i.e., not segments which require integration to form longer stick type RTDs). The snap together stick RTDs allow for a variety of linear placements and/or arrangements in a single device with an improved degree of certainty that the integrity of the lead wires will not be compromised. The housing materials preferably conform to IEE class H specifications, namely 180 degrees Celsius environments, with the preferred formulation rated to 200 degrees Celsius. It should be noted that in addition to temperature sensing elements, inductive sensors, pressure sensors, or other known sensing elements are contemplated, and are equally well suited for inclusion in the sensor assembly of the subject invention.

More specific features and advantages obtained in view of those features will become apparent with reference to the drawing figures and DETAILED DESCRIPTION OF THE INVENTION.

### BRIEF DESCRIPTION OF THE DRAWINGS

FIG. 1 is a perspective end view of the preferred sensor assembly of the subject invention, particularly illustrating a sensing element in relation to other assembly structures;

FIG. 2; is an end elevation view of the cover of the sensor assembly of FIG. 1;

FIG. 3 is an end elevation view of the base of the sensor assembly of FIG. 1;

FIG. 4 is an end elevation view of an alternate embodiment of the body of the sensor assembly of the subject invention; and

FIG. 5 is an end elevation view of yet a further embodiment of the body of the sensor assembly of the subject invention.

### DETAILED DESCRIPTION OF THE INVENTION

As a preliminary matter, it is to be understood that the sensor assembly of the subject invention is in no way limited to a particular functionality and/or application, with the subject invention being readily integrated into, or with, other structures, assemblies or devices in furtherance of the general functionality of the subject invention, namely that of sensing or detecting a monitorable condition (i.e., environmental parameter), change of condition etc. Although a preferred embodiment is illustrated in the figures and discussed hereafter, this too is in no way limiting, as the claims herewith define the scope of the subject invention.

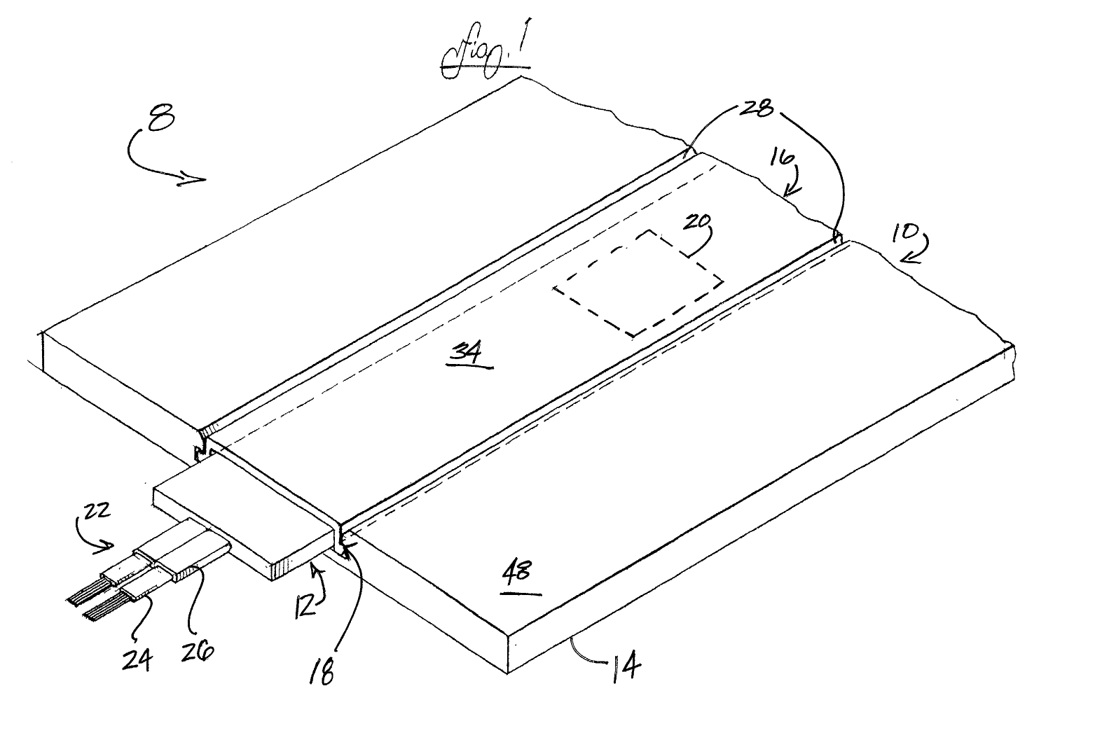

Referring now generally to FIG. 1, there is shown the preferred sensor assembly or device 8 of the subject invention. The sensor assembly 8 generally includes a housing 10 and at least one sensing element 12 positioned therein. The housing 10 includes a base 14 and a cover 16, the base 14 being adapted to receive at least a portion of the cover 16 so as to form an interface 18 therewith, thereby enclosing the one or more sensing elements 12 within the housing 10. Although the function of the sensing element or elements 12 are application determinative, the element or elements 12 generally include a sensing area 20, operably positioned within the housing 10 (e.g., by affixation of the sensing element 12 to either housing component (i.e., the base 14 or cover 16) such that sensing area 20 is desirably located), and leads 22 which are likely to further include insulation 24 and sleeving 26, as shown.

In a “stick” type stator temperature sensor (i.e., one wherein the body or housing has a longitudinal dimension orders of magnitude greater than a lateral dimension thereof so as to appear stick-like), the sensing element is preferably a resistance temperature detector (RTD). Other temperature sensors, such as thermocouples, thermistors and integrated circuit temperature elements are likewise suitable, again the nature of the sensing element being application specific.

Where the sensor is a RTD, the sensing area preferably includes a platinum, copper or nickel element. Acrylic resin coated fiberglass sleeved, tetrafluoroethylene (TFE) insulated leads of stranded American Wire Gage (AWG) #22 extend from the body for operative connection or integration with the sensing system.

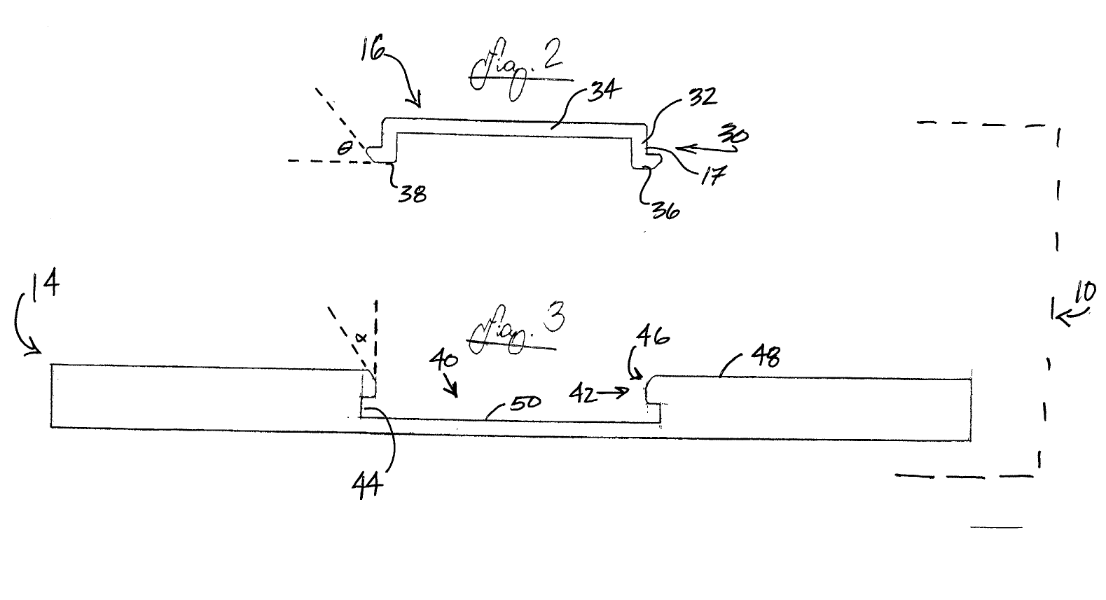

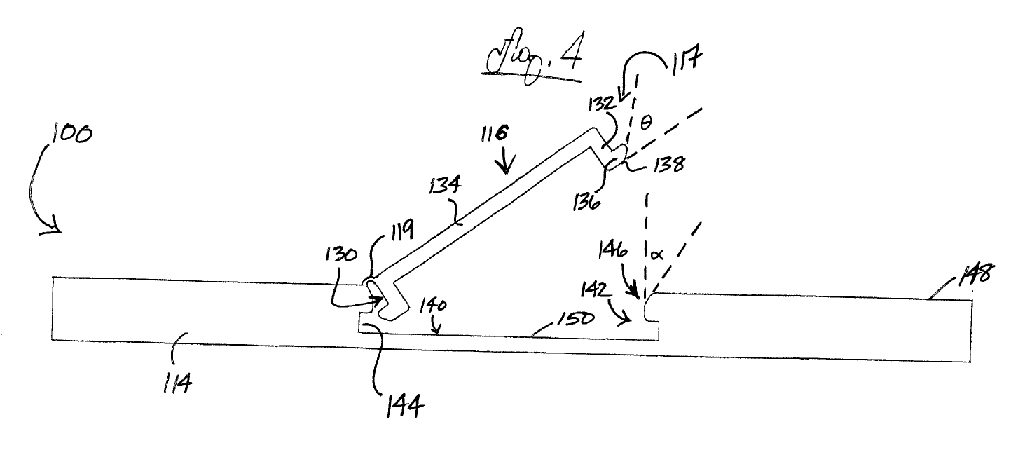

Referring now to FIGS. 1-3, the body 10 of the sensor assembly 8 preferably includes the elongate cover 16 (FIG. 2) and the elongate base 14 (FIG. 3), each being shown as discrete (i.e., separate) and unitary (i.e., of one-piece construction) elements. A sealant 28 is interposed between the cover 16 and the base 14 at or proximal the interface 18 formed therebetween so as to operatively isolate the sensing element 12 within the body 10. Although sealant selection is a function of application, depending also upon the material of construction of the body components, which is likewise a function of application, silicone, epoxy, and hot melt adhesives, to name but a few, are well suited for sealing the interface of the cover and body wherein the cover and body comprise a reinforced resin.

As is appreciated with reference to FIGS. 2 & 3, the cover 16 and base 14 are capable of reversible integration, more particularly, the cover 16 is interlockable with the base 14. The elongate cover 16 of FIG. 2 generally includes profiled longitudinal edges 30. Legs 32 downwardly depend from the central portion or spine 34 of the cover 16. Feet 36 (i.e., tabs or knobs) laterally extend from the legs 32, and away from a centerline of the spine 34, so as to be parallel therewith. The distal end of the lower or bottom surface 38 of each of the feet 36 are upwardly sloped at an angle θ of about 45 degrees from horizontal.

The sensing element 12 is preferably interposed between the legs 32 of the cover 16 as shown in FIG. 1. Towards this end, the sensing element 12 is preferably affixed to the spine 34 of the cover 16, as by adhesive (e.g., pressure sensitive) or other means known to those of skill in the art, or may alternately and suitably be affixed to the base 14.

The elongate base 14 of FIG. 3 generally includes a profiled longitudinal channel or slot 40, the profiled longitudinal edges 30 of the cover 16 being received therein, more particularly, the profiled longitudinal edges 30 of the cover 16 snap together with grooved sidewalls 42 of the longitudinal slot 40 of the elongate base 14. The groove 44 of the sidewalls 42 is generally configured to receive and retain the cover 16, namely the feet 36 thereof. A mouth or rim 46 of the channel 40, as defined by the intersection of the sidewalls 42 thereof with the upper or top surface 48 of the base 14, slopes downwardly toward a floor 50 of the channel 40, more particularly, the upper extremity of the sidewalls 42 slope up and outwardly from a centerline of the base 14 at an angle α of about 27 degrees from vertical.

Although the thickness of the body members are preferably uniform, the specific dimensions and geometries associated with the assembly and its components, namely the spatial relationships between the components of either or both the cover and the base, are synergistic and primarily a function of sensing element configuration and geometry, as well as the number of sensing elements intended for inclusion in the device. Be this as it may, it is highly desirable and advantageous to configure the cover in relation to the base such that these elements reversibly snap together.

A key point of distinction over heretofore known RTDs is the elimination of splices (i.e., the integration of discrete pieces) in the subject invention while maintaining stick flexibility. Further benefits accruing from the unitary nature of the body is ease and reliability of manufacture, including but not limited to ease of placement longitudinally of a plurality of sensing elements as wells as certain placement of lead wires exiting the sensing element for incorporation into a feedback or feed through (i.e., monitoring) system.

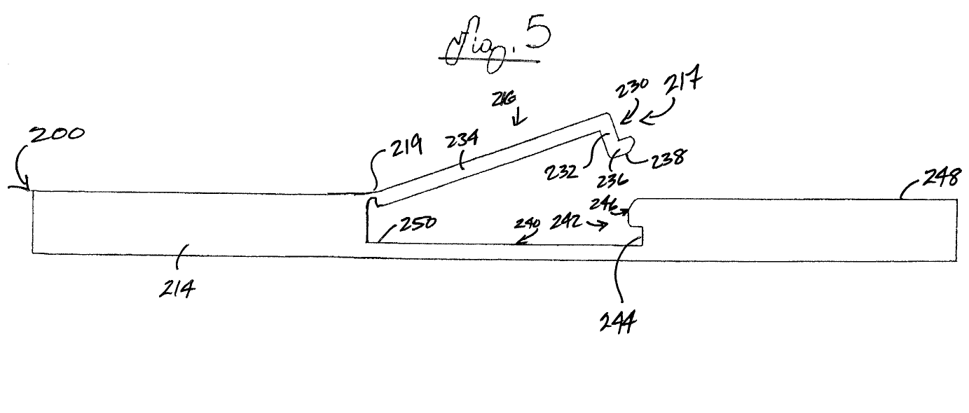

It is further noted that the snap together body or housing need not be two separate or discrete elements (i.e., pieces) as depicted in the embodiment of FIGS. 1-3. Instead the body may comprise a one piece hinged type construction as illustrated in the embodiments of FIGS. 4 & 5.

Referring now to the embodiments of FIGS. 4 & 5, wherein features of the respective embodiments are designated hereinafter using one hundred and two hundred series referenced numbers respectively, the alternate style body 100 (200) includes a base 114 (214) and a cover 116 (216) wherein the base 114 (214) is adapted to receive at least a portion of the cover 116 (216) so as to form an interface 118 (218) therewith, a portion of the cover 116 (216) being conjoined to a portion of the base 114 (214). The nature of the union between the cover and the base is that of a living or flex-hinge, such that a free longitudinal edge of the cover 117 (217) is hingedly positionable for receipt within a portion of the slotted base 114 (214). Although there exist numerous linkages known to effectuate the desired function, a simple tethering of the cover to the base which permits the snapping together of the elements is a minimum requirement. The flex-hinge 119 (219) need not extend the full longitudinal extent of the body 100 (200), flex-hinge segments are suitable as are other means of engaging the portions. Likewise, although the cover 116 (216) may be modified so as to at least have one longitudinal edge 117 (217), or again, at least segments thereof, receivable in a grooved sidewall 142 (242) of the slotted base 114 (214) (see FIG. 5), the cover 116 (216) may substantially conform with that shown in the embodiment of FIG. 2 (see FIG. 4), with economics likely dictating the style of the body 100 (200).

Common critical considerations for the subject invention discussed herein above is the ability to snap together portions of a unitary body, and to operatively seal the sensing element within the body, whether it be between the free edge or edges, or corresponding sides, of the body elements. After snapping together the body elements to substantially enclose the RTD element, the joints are sealed so as to environmentally isolate the RTD from physical contact. This is an important consideration in two respects. First longer stick RTDs will flex upon handling, with such flexure imparting stresses upon the sticks such that breakage (i.e., in the traditional laminate stick) or disassociation of two snapped together elements may occur. Second during the motor manufacturing process, the stick RTDs are positioned in stator slots, typically three sticks per phase and sometimes up to six sticks per phase, wherein after a vacuum pressure impregnation process evacuates air from the assembly and impregnates the assembly with insulative varnish which protects the assembly. It is important that the varnish, or other liquid or vapor, does not impregnate the stick RTD and thereby compromise the sensing element.

Preferably the body comprises a reinforced resin, more particularly a glass reinforced resin comprising about 10% glass resin. In the preferred stick RTD, a General Electric ULTEM 2100 reinforced resin is extruded or pultruded to obtain the sought after configurations for the cover and base. It should be understood that fabrication of the cover and base are neither limited to resins, reinforced resins, glass reinforced resins, nor extruded/pultruded glass reinforced resins. While extrusion and pultrusion are noted for formation of the body elements from the reinforced resin, other processes (e.g., machining, molding, etc.) known to those of skill in the art are similarly embraced hereby. Furthermore, and generally, the material of construction for the body is performance determinative.

While preferred embodiments of the present invention have been described, it should be understood that various changes, adaptations and modifications may be made therein without departing from the spirit of the invention. Changes may be made in details, particularly in matters of shape, size, material, and arrangement of parts without exceeding the scope of the invention. Accordingly, the scope of the invention is as defined in the language of the appended claims.

What is claimed is:

1. A sensor assembly comprising at least a single sensing element contained within a body comprising a base and a cover, said base adapted to receive at least a portion of said cover so as to form an interface therewith.

2. The sensor assembly of claim 1 wherein said cover and said base are reversibly integrated.

3. The sensor assembly of claim 2 wherein said cover is interlocked with said base.

4. The sensor assembly of claim 2 wherein said cover snaps together with said base.

5. The sensor assembly of claim 1 wherein a portion of said cover is conjoined to a portion of said base.

6. The sensor assembly of claim 5 wherein said base includes a longitudinal slot, said cover being adjacent said longitudinal slot.

7. The sensor assembly of claim 6 wherein a free longitudinal edge of said cover is hingedly positionable for receipt within a portion of said slot.

8. The sensor assembly of claim 4 further comprising a sealant, said sealant being interposed between said cover and said base at said interface so as to operatively isolate said sensing element within said body.

9. The sensor assembly of claim 4 wherein said base and said cover are discrete elements.

10. The sensor assembly of claim 9 wherein said base and said cover are unitary elements.

11. The sensor assembly of claim 10 wherein said base comprises a reinforced resin.

12. The sensor assembly of claim 11 wherein said reinforced resin comprises about 10% glass.

13. The sensor assembly of claim 11 wherein said cover comprises a reinforced resin.

14. The sensor assembly of claim 13 wherein said glass reinforced resin comprises about 10% glass.

15. The sensor assembly of claim 4 wherein said cover includes profiled longitudinal edges.

16. The sensor assembly of claim 15 wherein said base includes a profiled longitudinal channel, said profiled longitudinal edges of said cover being received within said profiled longitudinal channel of said base.

17. The sensor assembly of claim 16 wherein said sensing element is affixed between said profiled longitudinal edges of said cover.

18. The sensor assembly of claim 17 wherein said sensing element is affixed to said cover.

19. The sensor assembly of claim 16 wherein said sensing element is affixed to a floor of said profiled longitudinal channel of said base.

20. A sensing device comprising a housing and at least one sensing element, said housing comprising an elongate base having a longitudinal slot therein, and an elongate cover having at least a single profiled longitudinal edge, said at least a single profiled longitudinal edge being reversibly received in a portion of said longitudinal slot of said elongate base so as to enclose said at least one sensing element.

21. The sensing device of claim 20 wherein said at least one sensing element comprises a temperature sensor.

22. The housing of claim 20 wherein said at least a single profiled longitudinal edge snaps together with a profiled sidewall of said longitudinal slot of said elongate base.

23. The housing of claim 22 further including a sealant, said sealant being interposed between said at least a single profiled longitudinal edge and said profiled side wall.

24. A resistance temperature detector comprising at least one sensing element and a non-laminated body structure, said at least one sensing element being housed within said non-laminated body structure, said non-laminated body structure being receivable within stator windings of electrical machines.

25. The resistance temperature detector of claim 24 wherein said non-laminated body structure comprises an elongate base and a snap on cover for said elongate base.

26. The resistance temperature detector of claim 25 wherein said elongate base includes a longitudinal slot, said cover including a longitudinal edge adapted to be interlockingly received by a portion of said longitudinal slot.
